(19) United States
(12) Patent Application Publication
(10) Pub. No.: US 2017/0213611 A1
(43) Pub. Date: Jul. 27, 2017

(54) METHOD AND SYSTEM FOR HIGH EFFICIENCY ELECTRICITY GENERATION USING LOW ENERGY THERMAL HEAT GENERATION AND THERMIONIC DEVICES

(71) Applicants: Rodney T. Cox, North Plains, OR (US); Hans Walitzki, Portland, OR (US)

(72) Inventors: Rodney T. Cox, North Plains, OR (US); Hans Walitzki, Portland, OR (US)

(73) Assignee: Borealis Technical Limited, London (GB)

(21) Appl. No.: 13/893,318

(22) Filed: May 13, 2013

(51) Int. Cl. G21D 7/04; G21D 1/00; G21G 1/02; H01J 45/00

(52) U.S. Cl. CPC G21D 7/04; H01J 45/00; G21D 1/00; G21G 1/02; G21Y 2002/201

(57) ABSTRACT

A system and method are provided for generating electric power from relatively low temperature energy sources at efficiency levels not previously available. The present system and method employ recent advances in low energy nuclear reaction technology and thermionic/thermotunneling device technology first to generate heat and then to convert a substantial portion of the heat generated to usable electrical power. Heat may be generated by a LENR system employing nuclear reactions that occur in readily available materials at ambient temperatures without a high energy input requirement and do not produce radioactive byproducts. The heat generated by the LENR system may be transferred through one or more thermionic converter devices in heat transfer relationship with the LENR system to generate electric power.

### PRIORITY CLAIM

This application claims priority from U.S. Provisional Application No. 61/646,226, filed May 11, 2012, the disclosure of which is fully incorporated herein.

### TECHNICAL FIELD

The present invention relates generally to efficient energy production and specifically to the very efficient production of electrical energy possible with a system and method that employs low energy nuclear reaction heat generation and thermionic devices for the conversion of heat to electrical energy.

### BACKGROUND OF THE INVENTION

As the fossil fuel supplies currently used for electric power generation continue to be depleted, much effort has been directed toward finding suitable replacements. Such suitable replacements should efficiently produce the energy needed to meet the demands of a power-hungry world population without the adverse environmental effects of coal or other commonly used fossil fuels. While nuclear power produces electricity without these specific adverse environmental effects, nuclear reactors currently in use present their own environmental challenges. For example, spent fuel is radioactive and must be properly disposed of, and reactor cores must be constantly cooled with water that is then discharged into adjacent bodies of water, raising temperatures beyond levels that can sustain most living organisms. Earthquakes and other natural disasters can damage reactors and back-up safety systems, causing the release of high levels of radioactivity into the ground, air, and water surrounding a nuclear reactor, making the area uninhabitable. Particularly in the aftermath of the Fukushima nuclear power plant disaster following Japan's tsunami of 2011, cleaner, more reliable sources of energy for electric power generation that are not accompanied by these adverse environmental and health effects are being sought.

One approach to the search for an inexhaustible, environmentally-friendly source of energy exploits a phenomenon of nuclear physics in which the reaction product of two atomic nuclei has a slightly smaller mass than the mass of the original particles, and the mass difference is ultimately converted to heat energy. Only a minute mass difference yields a very large amount of heat energy. Thermonuclear reactions currently used to produce electric power, as well as those used in the past to produce hydrogen bombs, employ this phenomenon, which, as noted above, can be problematic.

The concept of low energy nuclear reactions (LENR), which also exploit this phenomenon and were generally referred to previously as cold fusion, has been under investigation for some time, but these reactions did not live up to their initial promise. Low energy nuclear reactions and their potential commercial applications have recently received renewed focus, however. It has long been known that reactions between atomic nuclei produce a significantly greater output of energy than chemical reactions between molecules, although such nuclear reactions usually require a correspondingly greater amount of energy to initiate. A substantial benefit of low energy nuclear reactions is that these nuclear reactions can be instituted at ordinary temperatures, corresponding to less than 1 electron volt (eV), and can achieve output energies in the range of one million eV or more. This is also characteristic of nuclear reactions that require large amounts of energy to initiate and large reactor facilities in which to conduct the reactions. LENRs, in distinct contrast, need only a very small fraction of the input energy, can be conducted on a much smaller scale, and do not produce residual radioactivity or radioactive waste. Until recently, however, these high energy producing reactions were confined to laboratory scale investigations.

In 2011, Dr. Andrea Rossi demonstrated that low energy nuclear reactions can produce the energy required for a 1 megawatt (MW) thermal heat generating plant from nickel and hydrogen. The extremely high energy density achieved was determined to be a factor of 100,000 or more compared to combustion processes using fossil fuels. With only a low energy input, this system produces an environmentally clean energy output without radioactive byproducts or carbon emissions. This system is described and shown in U.S. Patent Application Publication No. US2011/0005506. The LENRs on which the Rossi system is based are weak interactions and neutron capture processes that happen in nanometer to micron scale regions on surfaces of condensed matter at room temperature. The reactions involved are high energy nuclear reactions that transmute elements, primarily nickel to copper, but do not generate radioactive waste.

U.S. Patent Application Publication No. US2007/0280398 to Dardik et al and U.S. Pat. No. 7,244,887 to Miley disclose, respectively, electrolytic cells for the creation of LENRs that generate heat and electrolytic devices that may be used, inter alia, to generate heat, convert heat to electricity, and/or cause transmutation reactions. Miley additionally suggests electrolytic cells in which selected metals react with hydrogen and/or deuterium, but in a different arrangement than used by Rossi. None of the foregoing art, however, suggests a high efficiency system or method for producing electricity that converts heat generated by low energy nuclear reactions to electricity using thermionic or thermotunneling converters or similar devices.

The generation of electric power can be achieved by a variety of devices and systems, including, for example, diesel generators, thermoelectric converters, thermal electric power plants, and fuel cells, which vary in their efficiency. Thermionic converters proposed for electric current generation in the past have not only been inefficient, but have required high operating temperatures. More recent thermionic devices have been improved. However, neither these nor other electrical power generating systems and devices have been suggested as efficient producers of electric power from heat produced by LENRs.

A need exists, therefore, for a high efficiency system and method for generating electricity that combines the efficiencies of a LENR system of producing heat and a thermionic converter designed to operate with high efficiency to produce electricity from the heat produced by the LENR system.

### SUMMARY OF THE INVENTION

It is a primary object of the present invention, therefore, to provide a high efficiency system and method for generating electricity that combines the efficiencies of a LENR system of producing heat and a thermionic converter designed to operate with high efficiency to produce electricity from the heat produced by the LENR system.

It is another object of the present invention to provide a high efficiency electricity generation method and system capable of operating at efficiencies as high as 80% of Carnot.

It is an additional object of the present invention to provide a high efficiency electricity generation system and method that is substantially free from adverse environmental effects associated with available electricity generation systems from both fossil fuels and nuclear reactors.

It is a further object of the present invention to provide a method and system for efficiently producing electric power that is both compact and expandable to be used to provide electricity in a substantially unlimited range of applications.

It is yet a further object of the present invention to provide a highly efficient sustainable system and method for generating electrical energy from heat energy from relatively low temperature energy sources.

In accordance with the aforesaid objects, a system and method for generating electric power from relatively low temperature energy sources at efficiency levels not previously available is provided. The present system and method employ recent advances in low energy nuclear reaction technology and thermionic/thermotunneling device technology, first to generate heat, and then to convert a substantial portion of the heat to usable electrical power. Heat is generated by a LENR system premised on nuclear reactions, preferably those that occur in readily available materials at ambient temperatures and do not require high energy inputs or produce radioactive byproducts.

The heat generated by the LENR system is transferred through one or more thermionic converters or similar devices in heat transfer relationship with the LENR system to generate electric power.

Other objects and advantages will be apparent from the following description, drawings, and claims.

### BRIEF DESCRIPTION OF THE DRAWINGS

FIG. 1 is a diagrammatic representation of an electrode useful in a thermionic/thermotunneling converter device to generate electric current in accordance with the present invention;

FIG. 2 shows a cross sectional view of a preferred thermionic converter device, including the electrode of FIG. 1, useful for producing electric power from heat generated by a LENR system according to the present invention, showing active areas and the direction of heat flow through the thermionic converter device; and

FIG. 3 is a diagrammatic representation of the system of the present invention with one type of LENR system useful for generating heat to be processed by the thermionic converter device of FIG. 2 for the high efficiency generation of electric power.

### DESCRIPTION OF THE INVENTION

High efficiency systems and methods that produce electric power without adverse environmental impact have been the subject of much investigation, but available systems and methods have, thus far, fallen short of the concomitant goals of providing electric power with high efficiency and eliminating adverse environmental effects. It is becoming increasingly clear that reliance on existing or even new systems based on fossil fuels may not meet escalating global electric power demands without negatively impacting environmental quality. Although there may be available global fossil fuel reserves that have not been fully exploited, the combustion of fossil fuel using current technology to produce electricity can release undesirable levels of carbon, nitrogen, and sulfur oxides. Reliance on nuclear power plants for the electricity needs of a population dependent on electronic devices is also problematic, for environmental and other reasons. The present invention provides a unique alternative highly efficient power generation system and method capable of providing a substantially unlimited source of electric power without the potential adverse environmental and other consequences that characterize available power generation systems. The system and method of the present invention uses a low energy nuclear reaction (LENR) system to produce heat, which is converted to electric power by highly efficient thermionic/thermotunneling converter devices in heat exchange relationship with the LENR system. Both the preferred LENR system and the preferred thermionic/thermotunneling devices are capable of highly efficient operation at a wide range of levels.

Low energy nuclear reactions (LENR) are not based on nuclear fission or fusion, but, rather, are much weaker interactions that occur in condensed matter at ambient or room temperatures. Although weaker than fission or fusion reactions, LENRs are capable of producing highly energetic nuclear reactions and elemental transmutations. For virtually any nuclear reaction, the energy released is typically orders of magnitude greater than the energy released in a chemical reaction involving the same quantities of the same or similar reactants. LENRs, however, do not share the requirements or disadvantages of other nuclear reactions, which include very high input energy to start the process and the production of radioactive waste that must be disposed of. LENR systems are being widely studied, and a range of LENR systems has been proposed. Much of the experimental work relating to LENR is described in the papers available at www.lenr canr.org. There are many approaches to LENR systems that generate heat, including those described in U.S. Patent Application Publication No. US2007/0280398 to Dardik et al and U.S. Pat. No. 7,244,887 to Miley, referred to above in the Background of the Invention section. The LENR reactors described by Dardik et al and Miley include electrolytic cells, and the materials of the components of the electrolytic cells are selected to promote low energy nuclear reactions. Any of the known LENR systems that is capable of generating a supply of heat that can be converted to electrical energy by the thermionic converters in heat transfer relationship with the LENR system as described below could be used in the present system and method for high efficiency electric power generation. The LENR systems described herein are merely illustrative, and the present invention is not intended to be limited to use with any one specific LENR system.

The LENR system described by Rossi in U.S. Patent Publication No. 2011/0005506, the disclosure of which is incorporated herein by reference, and available under the name E-Cat in Australia and elsewhere is both compact and expandable and can be used effectively with the present system and method. The Rossi LENR system is premised on applying heat to a small amount of a micron-sized nickel powder in the presence of a catalyst in a pressurized hydrogen atmosphere to achieve a significant release of energy. Although the Rossi system is based on a reaction between nickel and hydrogen, a range of other nonradioactive metal elements may also be used to produce the desired LENR system, and these metals are also contemplated for use in the LENR system portion of the high efficiency electrical power generating system and method of the present invention.

An illustrative reactor core with a volume on the order of about 50 cubic centimeters (cm³) can use a few grams of nickel or other metal powder and a very small amount of hydrogen to safely produce about 10 kilowatts of heat. It has been demonstrated, for example, that the LENR reactor system of Rossi is self-sustaining and can continue to produce this amount of heat for six months or more. Additionally, if the temperature of the reactor becomes too high, unlike the situation in traditional nuclear reactors, the nickel or metal powder safely melts, destroying the reaction sites so that the nickel becomes unreactive, without the release of radioactive material. The addition of more nickel or metal is essentially all that is required to restart the process.

The energy produced by the reaction between nickel and hydrogen is presently used in the Rossi system to heat water or to produce saturated steam, primarily for applications requiring a reliable source of industrial heat in the 1 megaWatt (MW) range. An appropriate number of reaction vessel modules is connected together to provide this amount of heat. A smaller version of the Rossi LENR system, which is based on a single reaction vessel, is contemplated for residential use to provide hot water and heat in the 10 kiloWatt (kW) range. The connection of this LENR system to a typical diesel generator to produce electric power has been suggested. Diesel generators, however, present environmental and other problems. Not only are they very noisy, but they require fossil fuels with their accompanying noxious emissions for operation.

The high efficiency electricity generation system of the present invention is designed to use the heat produced by the LENR system described above or any other LENR system that effectively produces a source of heat without the drawbacks of traditional nuclear reactions. The heat produced by the LENR system is converted to electricity at a very high level of efficiency, up to as high as about 80% of Carnot efficiency, and preferably in the range of at least 50% of Carnot efficiency. Electrical power can be generated with the present system and method in an operating efficiency range of at least 10% of Carnot to 80% of Carnot. This very high operating efficiency is preferably achieved by one or more thermionic/thermotunneling converter devices as described below. Presently available thermoelectric converter devices used to produce electric energy claim to operate at higher than 10% of Carnot, but their long term operation is actually closer to about 5% of Carnot. The thermionic converters of the present invention represent a significant improvement over these available devices.

The thermionic/thermotunneling converter devices described herein can be more specifically described with reference to the following terms:

“Thermionic or thermotunneling converter” is hereby defined as either a device that uses a thermal gradient to create electrical power or a device that uses electrical power or energy to pump heat, thereby creating, maintaining, or degrading a thermal gradient. This may be accomplished using thermionics, thermotunneling, Avto effect, or other methods. In the present description of the invention, “thermotunneling” is used by way of an example only. The terms “Avto metal” and “Avto effect” are to be understood to describe a metal film having a modified shape that alters the electron energy levels inside an electrode modified accordingly, leading to a decrease in electron work function. The Avto effect enables the custom design of electron work function in a film or electrode to produce a desired work function range measured in electron volts (eV). Further, as used herein, the term “electrode” is intended to include either or both an anode or a cathode, as appropriate.

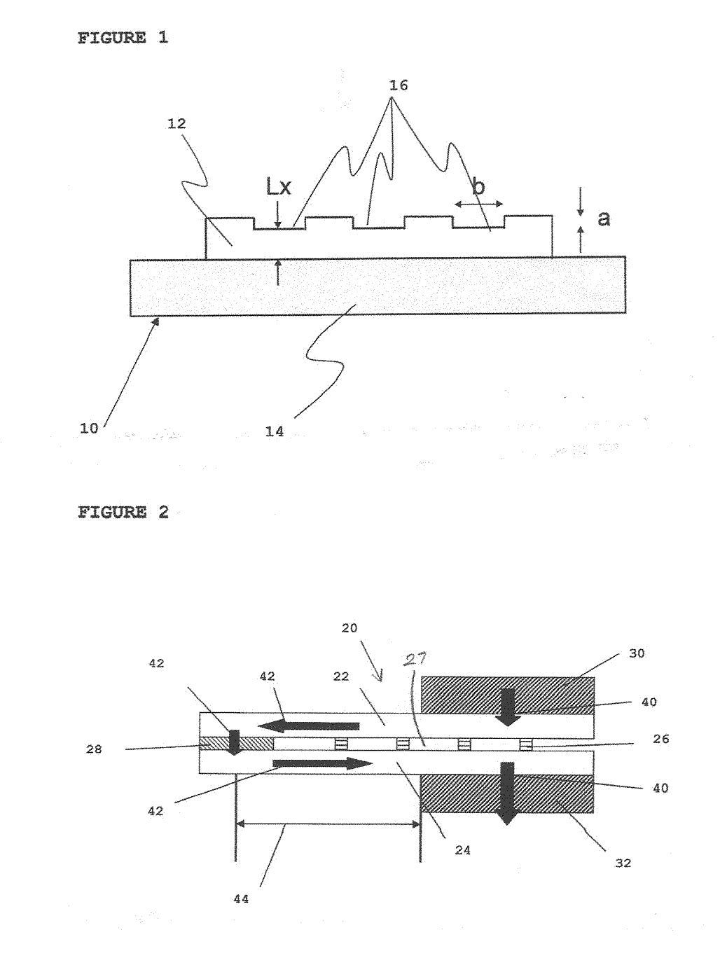

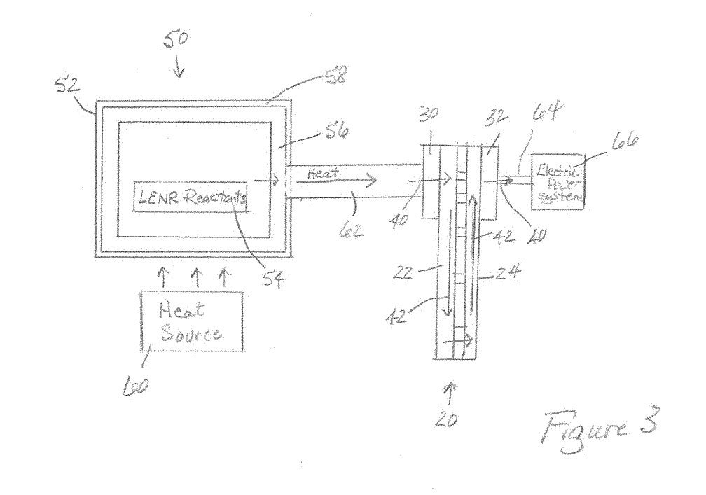

Thermionic and thermotunneling converter devices may include at least a pair of spaced electrodes maintained at a desired effective distance from each other by spacers without requiring the presence of active elements. Surfaces of such electrodes may or may not include Avto metals patterning. Devices of this type and a method for making such devices are described in commonly owned U.S. Patent Application Publication No. US2009/0223548 by Walitzki et al, the disclosure of which is incorporated herein by reference. The silicon-based devices shown and described herein provide useful and effective thermionic and/or thermotunneling converter devices. The owner of the present invention presently develops and provides thermionic and thermotunneling converter devices under the name POWER CHIPS™, as well as other related products. POWER CHIPS™ refers to devices that use a thermal gradient to create electric power. A preferred thermionic/thermotunneling (POWER CHIPS™) device for use in the system and method of the present invention is shown in FIGS. 1 and 2.

Referring to the drawings, FIG. 1 illustrates an Avto metal electrode structure 10 modified with a repeating pattern that has the shape and dimensions described below. The modified electrode may include a thin metal film 12 on one surface of a selected substrate 14 and may have a substantially planar surface with a pattern as shown and described herein. The pattern may be a repeating series of indents 16, and each indent may have a width b and a depth a relative to a height or thickness of the metal film 12, which is represented by Lx+a. The film 12 is preferably a metal with a surface that is as planar as possible, since surface roughness leads to the scattering of de Broglie waves during operation of the device. The indents 16 on the metal film 12 may be part of a sharply defined geometric pattern, such as that shown. Dimensions of indents may be selected that create a de Broglie wave interference pattern resulting in a decrease in electron work function. This facilitates emissions of electrons from a surface of the electrode and promotes transfer of elementary particles across a potential barrier. The surface configuration of the modified electrode may resemble a corrugated pattern of squared-off, “u”-shaped ridges and/or valleys. Alternatively, the pattern may be a regular pattern of rectangular “plateaus” or “holes,” where the pattern resembles a checkerboard. The walls of each indent 16 should be substantially perpendicular to one another, and edges of indents should be sharp. Methods of forming patterned electrode surfaces that produce the Avto effect are described and shown in commonly owned U.S. Pat. No. 6,117,344 to Cox et al, the disclosure of which is incorporated herein by reference.

While the dimensions of the indents required to produce the Avto effect may vary, a depth in the range of approximately 5 to 20 times a roughness of the surface and a width in the range of approximately 5 to 15 times the depth are preferred. The dimensions of the indents affect the transfer of electrons through the preferred thermionic and/or thermotunneling device and may be defined on a nanoscale level in nanometers, and the specific dimensions selected may vary.

FIG. 2 shows, in cross-section, a thermionic converter 20 suitable for use in the present system and method. The thermionic converter 20 may include a pair of electrodes 22 and 24, preferably an anode and a cathode that have facing surfaces with the configuration described above in connection with FIG. 1, with a plurality of spacers 26 that maintain the electrodes at a desired separation distance or gap 27. The device of FIG. 2 is able to maintain higher efficiency levels with much greater spacing between cathode and anode than has previously been possible, largely because of higher thermal toleration. Separation between electrodes may exceed the 50 nanometer gap distance disclosed in commonly owned U.S. Pat. No. 6,417,060 referred to above without sacrificing efficiency.

Each electrode 22 and 24 may have on surfaces facing the gap 27, the preferred Avto metal structure shown in FIG. 1, although other electrode structures may also be used. The electrodes of the thermionic converter 20 preferably have identical dimensions. A bond pad 28 may be positioned as shown at an end of and between the electrodes 22 and 24 to hold them in place. An element 30 that functions as an active area may be contiguous to and in heat transfer contact with the electrode 22 and in heat transfer relationship and thermal contact with a source of heat from one or more of the aforementioned LENR systems. A second element 32 that also functions as an active area may be contiguous to and in thermal contact with the electrode 24 and in thermal contact and heat transfer relationship with a heat sink. In the present system and method, the heat sink structure may transfer current generated by the thermionic converter 20 to an electrical energy or power destination or system 66, as shown and discussed in connection with FIG. 3 below. The elements 30 and 32 may or may not have Avto metals patterning. The thermal gradient produced across the thermionic converter 20 may generate electric current through a load in an external circuit, such as that represented by structures 64 and 66 in FIG. 3.

Although the thermionic converter 20 may be positioned directly between a heat source in contact with element 30 and a heat sink in contact with element 32, this is not intended to limit the scope of the present invention, but is provided to illustrate one possible arrangement of the heat transfer/electric power generation system of the present invention. Various methods for connecting thermionic converters in heat transfer relationship to a heat source produced by LENRs are possible and are contemplated to be within the scope of the present invention. A heat sink in thermal contact with the element 32 of the thermionic converter 20 may also be any one of a number of suitable heat sink structures for transferring heat energy to be transformed to electrical energy.

In some applications, in addition to the transfer of electric energy from the thermionic converter 20 to one or more external circuits, any waste heat at the heat sink in thermal contact with the element 32 or heat that is not converted to electrical energy may also be transferred, for example to a home heating or hot water system. In accordance with the present invention, one or more thermionic converters could be attached or otherwise secured and positioned in heat transfer relationship between components of a LENR system and components of an electrical power system.

Arrows 40 in FIG. 2 indicate the direction in which heat may flow through the thermionic converter 20 elements 30 and 32. Arrows 42 indicate the path along which the heat may travel through the electrodes 22 and 24. Elements 30 and 32 may not be in close proximity to the bond pad 28 holding the electrodes 22 and 24 in place, but may be separated by a distance represented by the arrow 44. As a result, there may be very little thermal leakage through the bond pad 28. In addition, edge thermal losses may be reduced when the effective area of the thermionic converter device 20 is enlarged or when length of the thermal path is increased by methods well known in the art.

Element 30, which is in contact with the low temperature side of the thermionic converter device of the present invention, may be formed of a suitable heat transfer material, such as, for example without limitation, a heat transfer material that can be formed directly on the electrode 22. Element 32, which is in contact with the high temperature side of the thermoelectric converter device of the present invention, may be formed from any one of a variety of materials suitable for heat transfer and/or the transfer of electric energy in a high temperature area. Suitable materials for these purposes may be selected from those available for this purpose.

FIG. 3 is a schematic illustration of one possible arrangement of a high efficiency electric power generating system 50 in accordance with the present invention. One kind of LENR system 50 that is currently available and may be used with present system is shown in FIG. 3. This is only one type of LENR system; it is contemplated that any other suitable LENR system that produces heat that can be converted to electric power as described herein could also be used in the present system. Not all LENR systems will necessarily include the components shown and described, which are intended merely to be illustrative. One suitable LENR system may include a reaction chamber or reactor 52 that is designed to accommodate a reaction vessel 54 containing the reactants and/or electrolytic cells required to produce an exothermic low energy nuclear reaction. A suitable heat source 60, capable of producing temperatures in the range required to start the reactions, provides this energy. Once the low energy nuclear reaction gets started, heat will be produced continuously by the reaction, and the heat source 60 may be inactivated. The reaction vessel 54 may be contained within a fluid-filled inner jacket 56 to provide a heat transfer fluid to be heated by the LENR. The heat transfer fluid could be a suitable liquid or gas. The LENR system may further include a lead or steel-coated lead outer jacket 58, or any other appropriate barrier material, to prevent the release of any radiation outside the system. Heat transfer fluid within the inner jacket 56 is heated by the heat produced by particle decay and nuclear transformations resulting from LENRs. This thermal energy may be transferred from the reactor 54 to, for example, a secondary fluid line 62 in heat transfer relationship with an element 30 in contact with an active area on the thermionic converter 20 of FIG. 2. This arrangement may be varied as required for a particular LENR system and is not intended to limit the scope of the present invention.

Heat entering the thermionic converter 20 from the fluid line 62 may be transferred along the path designated by arrows 40 and 42 (FIG. 2) to a heat sink in contact with element 32. As heat is transferred, the movement of electrons across the specifically configured electrodes, described in connection with FIG. 1, generates an electric current that can be directed out of the thermionic converter 20 through a suitable electrical connection 64 and/or electric circuits to provide electric power to a power destination 66.

While only one thermionic converter 20 is shown in FIG. 3, it is contemplated that any number of thermionic converters may be provided in thermal contact with a LENR system as needed to generate whatever amount of electric power is required. Since the preferred size of the basic reaction vessel 52 may be relatively small (about 50 cm³ in one LENR system), and the thermionic converter preferably may have a longest dimension in the range of about one inch (2.2 cm), the overall size of the present high efficiency electricity generating system can be quite small. The size of the system can be increased by connecting modules of LENR system reaction vessels and thermionic converters. The size flexibility and combined efficiencies possible with a suitable LENR system and thermionic converters of the present invention may allow the efficient generation of electric power in an essentially unlimited range of situations.

While the present invention has been described with respect to a limited number of embodiments, those skilled in the art will appreciate numerous modifications and variations therefrom. It is intended that the appended claims cover all such modifications and variations as fall within the true spirit and scope of this present invention.

### INDUSTRIAL APPLICABILITY

The present invention will find its primary applicability in providing a highly efficient electricity generating system that functions effectively at low cost in a wide range of possible applications.

1. A high efficiency electric power generating system comprising one or more low energy nuclear reaction generating means for producing a reliable source of heat and one or more thermionic converter means in heat transfer relationship with said low energy nuclear reaction generating means for receiving said reliable source of heat, wherein said thermionic converter means is configured to efficiently generate electric power from said reliable source of heat at an efficiency within the range from about 10% of Carnot to about 80% of Carnot efficiency.

2. The electric power generating system of claim 1, wherein said low energy nuclear power reaction generating means is designed to use low cost reactants to safely produce a heat generating reaction.

3. The electric power generating system of claim 1, wherein said thermionic converter means comprises at least a pair of electrodes separated by a gap, and each one of said pair of spaced electrodes has an Avto metal surface configuration on a surface of said electrode facing said gap.

4. The electric power generating system of claim 3, wherein said thermionic converter means further comprises a first active area in thermal contact between said low energy nuclear reaction generating means and one of said electrodes and a second active area in thermal and electrical contact between another of said electrodes and electric power destination means.

5. The electric power generating system of claim 1, wherein said source of heat comprises a heat transfer fluid selected from heat transfer fluids comprising liquids and gasses.

6. The electric power generating system of claim 1, wherein said low energy nuclear reaction generating means comprises barrier means designed and positioned to contain any radioactivity produced when said source of heat is produced.

7. The electric power generating system of claim 1, comprising a plurality of low energy nuclear reaction generating means positioned to be in heat transfer relationship with said one or more thermionic converter means.

8. The electric power generating system of claim 1, wherein a plurality of thermionic converter means is positioned to be in heat transfer relationship with said one or more low energy nuclear reaction generating means.

9. A high efficiency method for generating electric power from heat comprising:
a. providing at least one low energy nuclear reaction generator and activating said low energy nuclear reaction generator to produce a low energy nuclear reaction between reactants selected to produce a supply of heat;
b. providing at least one thermionic converter in heat transfer relationship with said low energy nuclear reaction generator, wherein said thermionic converter is designed to convert heat energy from said supply of heat to electric energy at an efficiency in the range from about 10% of Carnot to about 80% of Carnot;
c. directing said supply of heat from said low energy nuclear reaction generator to said thermionic converter;
d. transferring heat from said supply of heat through said thermionic convert to cause heat energy from said supply of heat to be converted to a supply of electrical energy; and
e. directing said supply of electrical energy to an electric power destination.

10. The method of claim 9, wherein said thermionic converter converts heat energy from said supply of heat to electric energy at an efficiency in the range of about 50% of Carnot to about 80% of Carnot.

11. The method of claim 9, wherein said reactants are selected to produce said supply of heat at ambient temperatures without discharging radioactive byproducts.

12. The method of claim 9, wherein said thermionic converter comprises a pair of spaced electrodes with facing surfaces having an Avto metal configuration, whereby heat energy from said supply of heat enhances a flow of electrons and current through said thermionic converter to produce electric energy.

13. The method of claim 9, wherein said supply of heat is increased by providing a plurality of low energy nuclear reaction generators in heat transfer relationship with said thermionic converter.

14. The method of claim 9, wherein said supply of electrical energy is increased by providing a plurality of thermionic converters in heat transfer relationship with said low energy nuclear reaction generator.

15. The method of claim 9, wherein said supply of heat comprises a heat transfer fluid in heat transfer contact between said low energy nuclear reaction generator and said thermionic converter.

16. The method of claim 9, wherein, in step d, any heat energy not converted to electrical energy is captured and used.

17. A system for efficiently converting heat energy into electrical energy using the method of claim 9, wherein said system comprises a low energy nuclear reaction generator designed to generate said supply of heat from nonradioactive metals in heat transfer contact with electrodes in said thermionic device configured and positioned to efficiently transfer energy from a heat source-contacting portion of said device to a heat sink-contacting portion of said device and to generate electrical energy as heat is transferred through said thermionic device.

18. The method of claim 9, wherein said supply of heat is produced by low temperature energy sources in said low energy nuclear reaction generator and directed to said thermionic converter to generate a sustainable supply of electrical energy.
